(19) United States
(12) Patent Application Publication
(10) Pub. No.: US 2013/0056369 A1
(43) Pub. Date: Mar. 7, 2013

(54) HOT FOOD CONTAINER MOISTURE ABSORBENT INSERT

(71) Applicant: Antoinette K. Jorgensen, American Fork, UT (US)

(72) Inventor: Antoinette K. Jorgensen, American Fork, UT (US)

(21) Appl. No.: 13/225,409

(22) Filed: Sep. 3, 2011

(51) Int. Cl. B65D 81/26; C09J 7/02; B32B 3/26; B32B 7/12; B32B 1/06; B65B 29/00; B32B 33/00

(52) U.S. Cl. 206/204; 53/400; 428/343; 428/41.8; 428/34.1; 428/317.3

(57) ABSTRACT

Devices (inserts) for preserving freshness of hot food in a container are taught. Exemplary inserts according to the present invention may include a first substrate formed from an adhesive material, and a second substrate formed from an absorbent material, the second substrate being coupled to the first substrate. The insert may also include a removable release layer in contact with the first substrate. The first substrate may be securely attached by the adhesive material to the interior of the container.

### FIELD

This application relates generally to food containers. In particular, this application relates to inserts for food containers that preserve freshness and crispness of hot food.

### BACKGROUND

Fast food and take-out hot food is a multi-billion dollar industry in the United States. Many traditional restaurants, in addition to the ubiquitous fast-food restaurants, offer take-out service to better serve their customers. Customers often enjoy eating their favorite restaurant food at home, on a picnic, or at some other location or event than the restaurant. The very reason that many restaurants are successful is that the purveyors of those restaurants provide unique and tasty food unavailable elsewhere, making food from a particular restaurant desirable, even when attending other functions or locations.

To serve the take-out and fast food markets, many different disposable containers have been used to attempt to preserve heat and freshness of hot food while being transported for later consumption. Two of the most common types of containers are Styrofoam® (or other similar molded plastic) containers and the cardboard, or paperboard containers. Often, however, these containers trap moisture inside of the containers. As the containers are covered to keep heat in so that the food remains hot or warm as long as possible, steam and moisture escaping from the hot food tends to collect on the top and on the inside surfaces of the container, often dripping or otherwise moistening the food.

Often, a disposable take-out container will include different types of food in a single presentation, such as fries and meat. Fries that are exposed to the moisture inside of the containers tend to go soggy and lose the crispiness that fries are often known and loved for. As such, many take-out containers can lead to the take-out hot food placed in the containers, particularly crispy, toasted, or fried foods becoming soggy after just a few minutes. Soggy bread, fries, other fried foods, and other food susceptible to being affected by the moisture trapped in traditional take-out containers are not as they were prepared and intended to be eaten by the restaurant. Such food is also generally not as well received by customers who expect the type of food they have come to expect and love from their favorite restaurant.

### SUMMARY

Devices (inserts) for preserving freshness of hot food in a container are taught. Exemplary inserts according to the present invention may include a first substrate formed from an adhesive material, and a second substrate formed from an absorbent material, the second substrate being coupled to the first substrate. The insert may also include a removable release layer in contact with the first substrate. The first substrate may be securely attached by the adhesive material to the interior of the container.

In some embodiments, the insert may include a gas and water vapor permeable outer layer. In various embodiments, the absorbent material may be cotton, combined cotton, or any other suitable material. The absorbent material in the insert may be affixed to an inner surface of the disposable container, and may absorb water vapor and increase the time the hot food can be in the disposable container without becoming soggy.

Some embodiments of methods for preserving freshness in hot food may include providing a container for hot food, the container having a closable lid, and affixing a moisture absorbing device to the interior of the container. Such methods may also include placing hot food in the container, and transporting the container and hot food. In some embodiments, the container is formed from thermoplastic, a paper product, or any other suitable material. In various embodiments, the affixing may be performed at a restaurant, or may be performed prior to shipping the container to a restaurant for use by the restaurant.

### BRIEF DESCRIPTION OF THE DRAWINGS

The following description can be better understood in light of Figures, in which:

FIG. 1 illustrates an exemplary moisture absorbing device placed in a take-out food container;

FIG. 2 illustrates the function of an exemplary moisture absorbing device in a take-out food container with hot food;

FIG. 3 illustrates a cross-section of an exemplary moisture absorbing device in a take-out food container;

FIG. 4 is a top view of an exemplary moisture absorbing device;

FIG. 5 is a side view of an exemplary moisture absorbing device;

FIG. 6 is a perspective bottom view of an exemplary moisture absorbing device;

FIG. 7 is a perspective top view of an exemplary moisture absorbing device; and

FIG. 8 is a perspective tip view of an exemplary moisture absorbing device with indicia.

Together with the following description, the Figures demonstrate and explain the principles of the apparatus and methods for using the moisture absorbing device. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry. For example, while the description below focuses on exemplary moisture absorbing devices in hot food take-out containers formed of plastic foam, the device may be sized for and used with hot-food containers of any shape and made from any material.

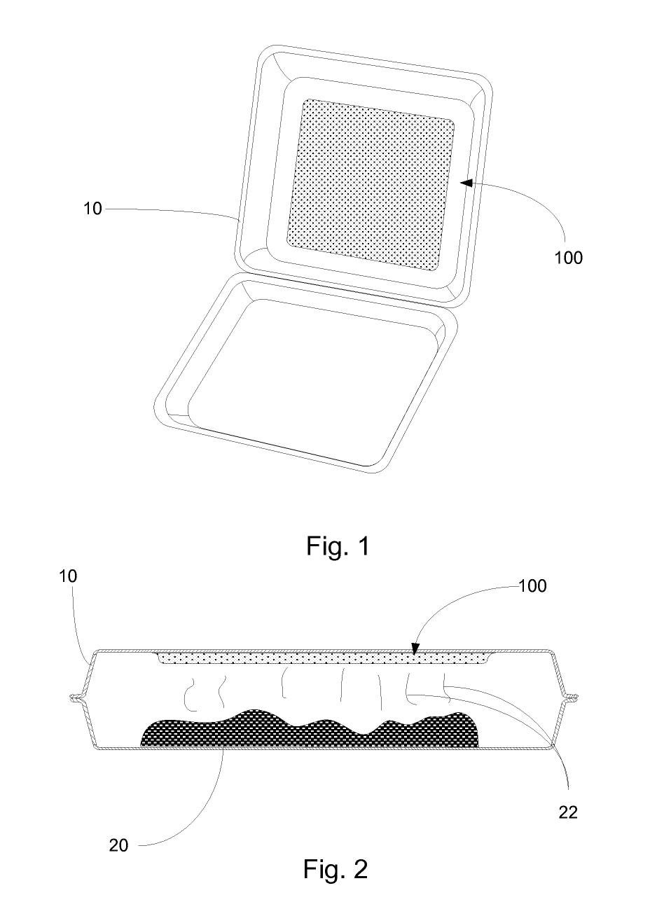

FIGS. 1 and 2 illustrate food container 10, which may be used for serving and/or transporting hot food 20. In the figure, insert 100 is included inside of the top portion of food container 10. As shown in FIG. 2, insert 100 may be used to absorb steam or other moisture vapor 22 to allow food 20 to remain fresher longer by preventing excess moisture from depositing on food 20. Insert 100 may be particularly effective when food 20 is fried, crispy, or soft food, such as french fries, toast, bread, or other food that may be adversely affected by excess steam.

Additionally, insert 100 may also provide additional insulation to keep heat within container 10 for a longer period of time than without insert 100. Insert 100 may also function to maintain higher heat longer by reducing the evaporative cooling effect that can occur when water collects on the interior surface of container 10 due to excess steam and condensation by reducing the water surface area available for evaporation.

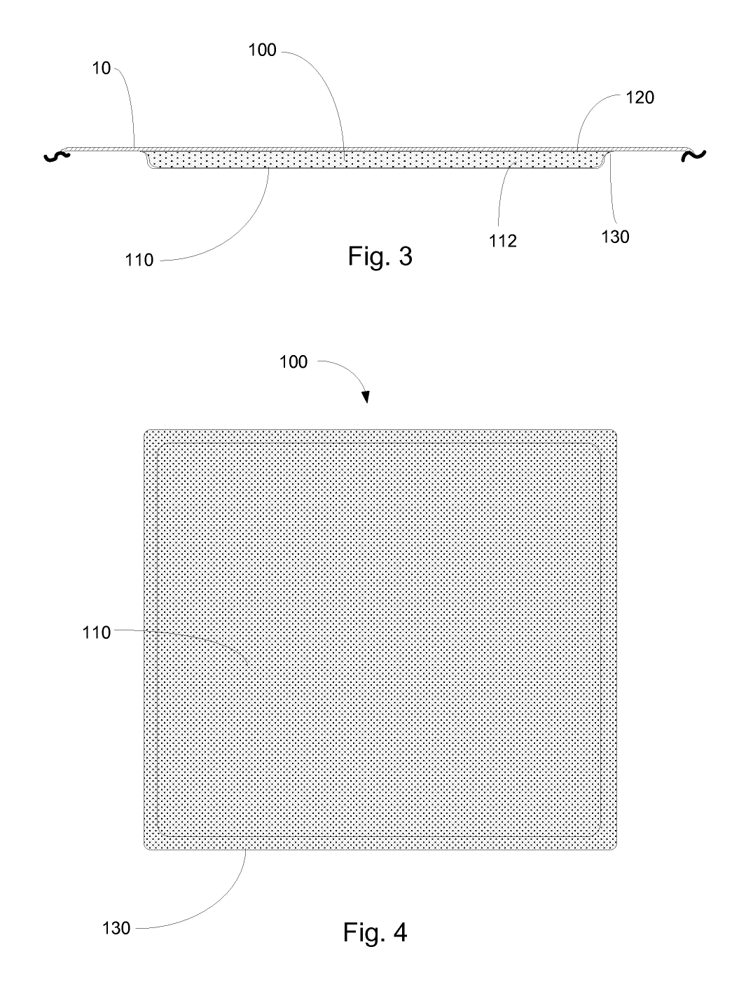

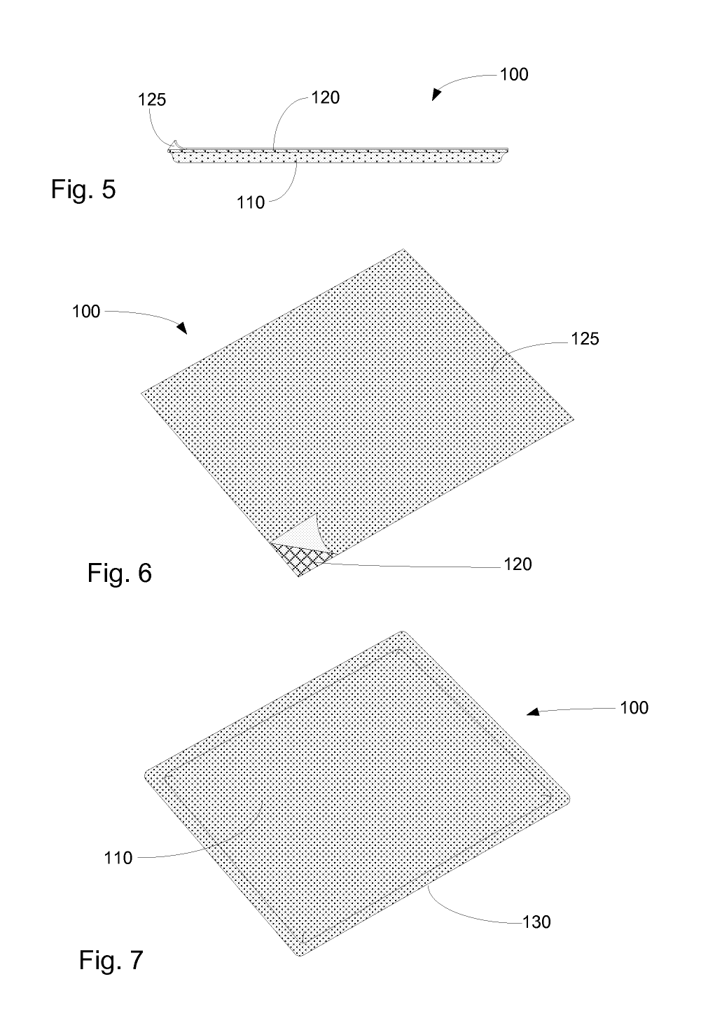

As shown in FIGS. 3-7, insert 100 may include absorbent layer 110 and adhesive layer 120. In some embodiments, release sheet 125 may be provided to allow adhesive layer 120 to be protected until use when release sheet 125 can be removed and insert 100 attached in its position using adhesive layer 120. Similarly insert 100 may further include outer layer 130 to protect or hold absorbent layer 120 in place.

Absorbent layer 120 may be formed of any suitable material, such as cotton, combined cotton, layered woven materials, etc. Similarly, absorbent layer 120 may have a thickness between about 1/16 to about ½ inch, depending on the application and materials used. Absorbent layer 120 may also include additional materials such as powders, cellulose, or other absorbent materials. Such materials may be impregnated in other materials or may be held in place by outer layer 130.

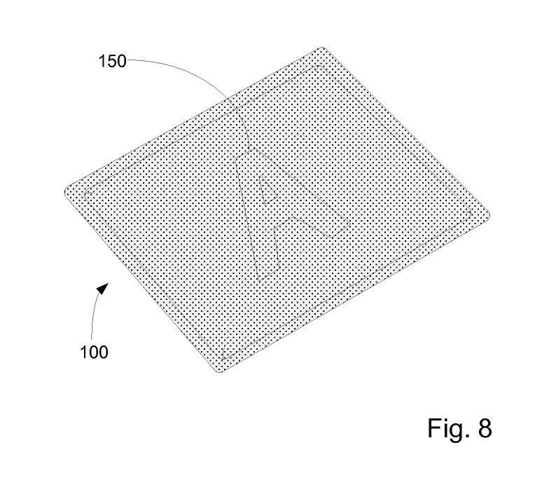

As shown in FIG. 8, absorbent layer 120, with or without outer layer 130, may include embossing or a type of embroidery or printing to place designs or logos 150 on insert 100. In some embodiments, the embossing or other similar process 150, may provide pockets to hold the material in absorbent layer 120 in a desirable distribution throughout insert 100. For example, if cellulose is used, sectioning absorbent layer 120 of insert 100 with embossing or embroidery 150 may allow for even distribution of the cellulose material and maintain a desired thickness of insert 100. Designs, shapes, and/or logos 150 may reflect the trademarks or other identifying features of a particular restaurant.

Insert 100 may be any suitable size for an appropriate container. For example, a 5″×5″ insert 100 may be suitable for use with an 8″×8″ inch foam plastic container. Or a 2″×5″ insert 100 may be suitable for use with a 3″×6″ cardboard container. The size of insert 100 may vary according to the size and materials of container 10, and may also vary based on the types and quantities of hot food 20 placed in container 10. For example, a larger and/or thicker insert 100 may be desired if food 20 includes a cup of very hot chili and a large number of fries in order to keep the fries crispy with the considerable steam produced by the chili. A much smaller insert may be required to maintain a fresh roll with slices of hot meat. The appropriate size and thickness of an insert for a particular application can be readily determined with simple trial efforts.

Suitable containers 10 may be formed from any of various materials, such as thermoplastics (including Styrofoam® or other similar materials), other plastics, cardboard, paper board and other paper products, aluminum, or any other suitable hot-food container, as are available to those of ordinary skill in the art.

In some circumstances, hot food may be kept in a more desirable condition with insert 100 for up to 45 minutes as compared to only a few minutes without an insert. In some embodiments, larger and thicker inserts may provide for a longer heat and freshness time, as desired.

Adhesive layer 120 may be a contact adhesive, spray-on adhesive, double-sided adhesive tape, or any other suitable adhesive. Many such suitable adhesives are available and are known to those of ordinary skill. Similarly, insert 100 may be manufactured with adhesive layer 120 and release sheet 125 for placement into container 10 in a restaurant. Or, in other embodiments, insert 100 may be affixed to container 10 during the manufacturing process of container 10 and shipped to individual restaurants with insert 100 in place. In such circumstances, a spray-on adhesive or any other suitable adhesive may be used to form adhesive layer 120.

Release sheet 125 may be formed of any material that will readily release from adhesive layer 120, while allowing adhesive layer 120 to maintain its adhesive properties. Adhesive layer 120 may be selected for significant adhesion since container 10, along with insert 100, is generally disposable and it is undesirable for insert 100 to become detached from container 10 and thereby contact food 20. Thus, adhesive layer 120 may be sufficiently sticky as to make removal of insert 100 from container 10 without damaging or destroying either insert 100 or container 10.

Outer layer 130 may provided or omitted, depending on the material used in absorbent layer 110 and/or a desired aesthetic presentation. In some embodiments, outer layer 130 may be formed from a material that is water vapor permeable, but resists allowing liquid water from passing through, such as fabrics formed from ptfe, or other similar materials. While in other embodiments, outer layer 130 may be a simple woven fabric suitable to allow water vapors to penetrate into absorbent layer 110.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A device for preserving freshness of hot food in a container, comprising:
a first substrate formed from an adhesive material;
a second substrate formed from an absorbent material, the second substrate being coupled to the first substrate; and
wherein the first substrate is configured to be securely attached by the adhesive material to the interior of the container.

2. The device of claim 1, further comprising a removable release layer in contact with the first substrate.

3. The device of claim 1, wherein the first substrate is securely attached by the adhesive material to the interior of the container.

4. The device of claim 1, further comprising an outer layer.

5. The device of claim 4, wherein the outer layer is gas and water vapor permeable.

6. The device of claim 1, wherein the absorbent material is cotton.

7. The device of claim 6, wherein the cotton is combined cotton.

8. A device for preserving freshness of hot food, comprising:
a disposable container configured to transport and cover hot food and limit heat loss of the hot food; and
an absorbent material affixed to an inner surface of the disposable container, wherein the absorbent material absorbs water vapor and increases the time the hot food can be in the disposable container without becoming soggy.

9. The device of claim 8, further comprising an outer layer.

10. The device of claim 9, wherein the outer layer is gas and water vapor permeable.

11. The device of claim 8, wherein the absorbent material is cotton.

12. The device of claim 11, wherein the cotton is combined cotton.

13. A method for preserving freshness in hot food, the method comprising:
providing a container for hot food, the container having a closable lid; and
affixing a moisture absorbing device to the interior of the container.

14. The method of claim 13, further comprising:
placing hot food in the container; and
transporting the container and hot food.

15. The method of claim 13, wherein the container is formed from thermoplastic.

16. The method of claim 13, wherein the container is formed from a paper product.

17. The method of claim 13, wherein the affixing is performed at a restaurant.

18. The method of claim 13, wherein the affixing is performed prior to shipping the container to a restaurant for use by the restaurant.
